(19) United States
(12) Patent Application Publication
(10) Pub. No.: US 2026/0139111 A1
(43) Pub. Date: May 21, 2026

(54) COMPOSITE MATERIAL OR COMPOSITE MATERIAL LAYER WITH THERMAL BARRIER PROPERTIES

(71) Applicant: SAINT-GOBAIN PERFORMANCE PLASTICS CORPORATION, Malvern, PA (US)

(72) Inventors: Fei WANG, Winchester, MA (US); Katherine E. POKHREL, Framingham, MA (US); Cassandra T. TUBBS, Boylston, MA (US); Chuanping LI, Shrewsbury, MA (US); Anton Lee COTTRILL, Arlington, MA (US); Rachel Catherine BROWN, Apex, NC (US); Antoine GUIU, Lyon (FR); Refet Ali YALCIN, Lamorlaye (FR)

(21) Appl. No.: 19/388,314

(22) Filed: Nov. 13, 2025

Related U.S. Application Data
(60) Provisional application No. 63/720,867, filed on Nov. 15, 2024.
(60) Provisional application No. 63/872,887, filed on Aug. 29, 2025.

(51) Int. Cl. C08J 9/00; C08K 3/12; C08K 3/22; C08K 3/34

(52) U.S. Cl. CPC C08J 9/0042; C08K 3/12; C08K 3/22; C08K 3/34; C08K 2201/009

(57) ABSTRACT

The present disclosure relates to a composite material that may include a silicone-based matrix component, an endothermic filler component distributed within the silicone-based matrix component, an insulative filler component distributed within the silicone-based matrix component, and an enhancing filler composition distributed within the silicone-based matrix component. The enhancing filler composition may include an opacifying filler component, a stabilizing filler component, or any combination thereof.

This application claims priority under 35 U.S.C. § 119 (e) to U.S. Provisional Patent Application No. 63/720,867, entitled “COMPOSITE MATERIAL OR COMPOSITE MATERIAL LAYER WITH THERMAL BARRIER PROPERTIES”, filed Nov. 15, 2024, by Fei WANG et al., and claims priority under 35 U.S.C. § 119 (e) U.S. Provisional Patent Application No. 63/872,887, entitled “COMPOSITE MATERIAL OR COMPOSITE MATERIAL LAYER WITH THERMAL BARRIER PROPERTIES”, filed Aug. 29, 2025, by Fei WANG et al., both of which are assigned to the current assignee hereof and are incorporated herein by reference in their entireties.

### FIELD OF THE DISCLOSURE

The present disclosure relates to a composite material or composite material layer and, in particular, a composite material or composite material layer for use as a thermal barrier in various applications, for example, in a battery pack, and methods of forming the same.

### BACKGROUND

Composite material or composite material layers and/or films may be designed for high temperature protection in various applications, for example, for use as thermal barriers in electric vehicle battery packs, thermal barrier coverings in high temperature cable protection, thermal barrier containers for thermal spray containment, etc. However, in these, and in other applications, potential heat growth continues to increase due to improvements in technology. Accordingly, there is a continuing need for improved barrier designs that protect against such high heat potential.

### SUMMARY

According to a first aspect, a composite material may include a silicone-based matrix component, an endothermic filler component distributed within the silicone-based matrix component, an insulative filler component distributed within the silicone-based matrix component, and an enhancing filler composition distributed within the silicone-based matrix component. The enhancing filler composition may include an opacifying filler component, a stabilizing filler component, or any combination thereof.

According to another aspect, a composite material layer may include a composite material. The composite material may include a silicone-based matrix component, an endothermic filler component distributed within the silicone-based matrix component, an insulative filler component distributed within the silicone-based matrix component, and an enhancing filler composition distributed within the silicone-based matrix component. The enhancing filler composition may include an opacifying filler component, a stabilizing filler component, or any combination thereof.

### BRIEF DESCRIPTION OF THE DRAWINGS

Embodiments are illustrated by way of example and are not limited to the accompanying figures.

FIG. 1 includes an illustration of a layer of composite material according to certain embodiments described herein.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to a composite that may include a silicone based matrix component, an endothermic filler component distributed within the silicone-based matrix component, an insulative filler component distributed within the silicone-based matrix component, and an enhancing filler composition distributed within the silicone-based matrix component. According to still other embodiments, the enhancing filler composition may include an opacifying filler component, a stabilizing filler component, or any combination thereof.

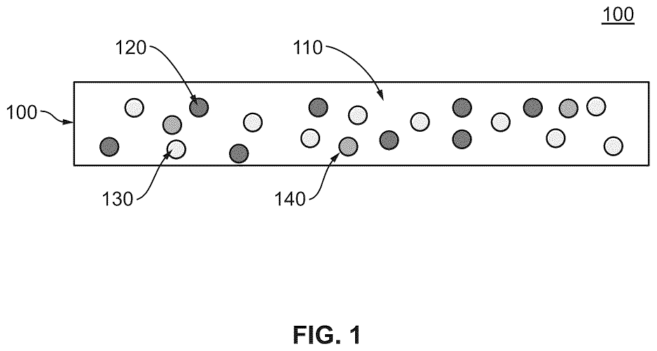

For purposes of illustration, FIG. 1 shows a layer of a composite material 100 according to embodiments described herein. As shown in FIG. 1, a composite material 100 may include a silicone based matrix component 110, an endothermic filler component 120 distributed within the silicone-based matrix component 110, an insulative filler component 130 distributed within the silicone-based matrix component 110, and an enhancing filler composition 140 distributed within the silicone-based matrix component 110.

According to particular embodiments, the silicone-based matrix component 110 may include a foam material. According to yet other embodiments, the silicone-based matrix component 110 may consist essentially of a foam material. According to yet other embodiments, the silicone-based matrix component 110 may be a foam material. According to yet other embodiments, the silicone-based matrix component 110 may be a foam material layer.

According to particular embodiments, the silicone-based matrix component 110 may include a solid material. According to yet other embodiments, the silicone-based matrix component 110 may consist essentially of a solid material. According to yet other embodiments, the silicone-based matrix component 110 may be a solid material. According to yet other embodiments, the silicone-based matrix component 110 may be a solid material layer.

According to yet other embodiments, the silicone-based matrix component 110 may have a particular porosity, which, for purposes of embodiments described herein, is equal to (theoretical density a sample-actual density of the sample)/theoretical density of sample*100. For example, the silicone-based matrix component 110 may have a porosity of at least about 10%, such as, at least about 15% or at least about 20% or at least about 25% or at least about 30% or at least about 35% or at least about 40% or at least about 45% or even at least about 50%. According to still other embodiments, the silicone-based matrix component 110 may have a porosity of not greater than about 80%, such as, not greater than about 75% or not greater than about 70% or not greater than about 65% or even not greater than about 60%. It will be appreciated that the porosity of the silicone-based matrix component 110 may be within a range between any of the values noted above. It will be further appreciated that the porosity of the silicone-based matrix component 110 may be any value between any of the values noted above.

According to yet other embodiments, the silicone-based matrix component 110 may have a particular hardness as measured using a durometer according to ASTM D2240. For example, the silicone-based matrix component 110 may have a hardness of at least about Shore00 25. According to still other embodiments, the silicone-based matrix component 110 may have a hardness of not greater than about ShoreD 40.

According to certain embodiments, the composite material 100 may include a particular content of the silicone-based matrix component 110. For example, the composite material 100 may include a silicone-based matrix component content of at least about 10 wt. % for a total weight of the composite material, such as, at least about 15 wt. % or at least about 20 wt. % or at least about 25 wt. % or at least about 30 wt. % or at least about 35 wt. % or even at least about 40 wt. %. According to yet other embodiments, the composite material 100 may include a silicone-based matrix component content of not greater than about 66 wt. % for a total weight of the composite material, such as, not greater than about 65 wt. % or not greater than about 60 wt. % or not greater than about 55 wt. % or even not greater than about 50 wt. %. It will be appreciated that the silicone-based matrix component content of the composite material 100 may be within a range between any of the values noted above. It will be further appreciated that the silicone-based matrix component content of the composite material 100 may be any value between any of the values noted above

According to particular embodiments, the silicone-based matrix component 110 may include platinum catalyzed addition cured silicone foam. According to yet other embodiments, the silicone-based matrix component 110 may include peroxide cured silicone foam. According to yet other embodiments, the silicone-based matrix component 110 may include tin catalyzed silicone foam. According to still other embodiments, the silicone-based matrix component 110 may include any combination of a platinum catalyzed addition cured silicone foam, a peroxide cured silicone foam, and a tin catalyzed silicone foam.

According to still other embodiments, the endothermic filler component 120 may include a component selected from the group consisting of a metal hydrate, a metal hydroxide, a metal silicate, a metal carbonate, a metal bicarbonate, an aluminum oxide, an ammonium nitrate, a metal sulphate, a metal phosphate, and any combination thereof. According to a particular embodiment, the endothermic filler component 120 may consist essentially of a component selected from the group consisting of a metal hydrate, a metal hydroxide, a metal silicate, a metal carbonate, a metal bicarbonate, an aluminum oxide, an ammonium nitrate, a metal sulphate, a metal phosphate, and any combination thereof.

According to yet other embodiments, the endothermic filler component 120 may include a metal hydrate, where the metal hydrate may include aluminum trihydrate, zinc borate, hydromagnesite, gypsum, sodium tetraborate decahydrate, or magnesium phosphate octahydrate. According to still other embodiments, the endothermic filler component 120 may include a metal hydrate, where the metal hydrate may consist essentially of aluminum trihydrate, zinc borate, hydromagnesite, gypsum, sodium tetraborate decahydrate, or magnesium phosphate octahydrate.

According to yet other embodiments, the endothermic filler component 120 may include a metal hydroxide, where the metal hydroxide may include magnesium hydroxide, dihydroxide, trihydroxide, dawsonite, or calcium hydroxide. According to still other embodiments, the endothermic filler component 120 may include a metal hydroxide, where the metal hydroxide may consist essentially of magnesium hydroxide, dihydroxide, trihydroxide, dawsonite, or calcium hydroxide.

According to yet other embodiments, the endothermic filler component 120 may include a metal silicate, where the metal silicate may include hydrous sodium silicate. According to still other embodiments, the endothermic filler component 120 may include a metal silicate, where the metal silicate may consist essentially of hydrous sodium silicate.

According to yet other embodiments, the endothermic filler component 120 may include a metal carbonate, where the metal carbonate may include nesquehonite, magnesium carbonate, Huntite, dawsonite, or anhydrous carbonates. According to still other embodiments, the endothermic filler component 120 may include a metal carbonate, where the metal carbonate may consist essentially of nesquehonite, magnesium carbonate, Huntite, dawsonite, or anhydrous carbonates.

According to yet other embodiments, the endothermic filler component 120 may include a metal bicarbonate, where the metal bicarbonate may include sodium bicarbonate. According to still other embodiments, the endothermic filler component 120 may include a metal bicarbonate, where the metal bicarbonate may consist essentially of sodium bicarbonate.

According to yet other embodiments, the endothermic filler component 120 may include an aluminum oxide, where the aluminum oxide may include boehmite. According to still other embodiments, the endothermic filler component 120 may include an aluminum oxide, where the aluminum oxide may consist essentially of boehmite.

According to yet other embodiments, the endothermic filler component 120 may include a metal hydrate, where the metal hydrate may include ammonium nitrate. According to still other embodiments, the endothermic filler component 120 may include a metal hydrate, where the metal carbonate may consist essentially of ammonium nitrate.

According to yet other embodiments, the endothermic filler component 120 may include a metal sulphate, where the metal sulphate may include anhydrous sulphate. According to still other embodiments, the endothermic filler component 120 may include a metal sulphate, where the metal sulphate may consist essentially of anhydrous sulphate.

According to yet other embodiments, the endothermic filler component 120 may include a metal phosphate, where the metal phosphate may include anhydrous phosphate. According to still other embodiments, the endothermic filler component 120 may include a metal phosphate, where the metal phosphate may consist essentially of anhydrous phosphate.

According to certain embodiments, the composite material 100 may include a particular content of the endothermic filler component 120. For example, the composite material 100 may include an endothermic filler component content of at least about 15 wt. % for a total weight of the composite material, such as, at least about 20 wt. % or at least about 25 wt. % or at least about 30 wt. % or at least about 35 wt. % or at least about 40 wt. % or at least about 45 wt. % or at least about 50 wt. % or at least about 55 wt. % or even at least about 60 wt. %. According to yet other embodiments, the composite material 100 may include an endothermic filler component content of not greater than about 75 wt. % for a total weight of the composite material, such as, not greater than about 70 wt. % or even not greater than about 65 wt. %. It will be appreciated that the endothermic filler component content of the composite material 100 may be within a range between any of the values noted above. It will be further appreciated that the endothermic filler component content of the composite material 100 may be any value between any of the values noted above.

According to still other embodiments, the insulative filler component 130 may include a component selected from the group consisting of perlite, hollow glass beads, aerogel, expanded perlite, unexpanded perlite, glass beads, ceramic beads, vermiculite, expanded vermiculite, expanded glass, zeolite, aerogel, silica, porous silica, porous alumina, or any combination thereof. According to a particular embodiment, the endothermic filler component 120 may consist essentially of a component selected from the group consisting of perlite, hollow glass beads, aerogel, expanded perlite, unexpanded perlite, glass beads, ceramic beads, vermiculite, expanded vermiculite, expanded glass, zeolite, aerogel, silica, porous silica, porous alumina, or any combination thereof.

According to certain embodiments, the composite material 100 may include a particular content of the insulative filler component 130. For example, the composite material 100 may include an insulative filler component content of at least about 1.0 wt. % for a total weight of the composite material, such as, at least about 3.0 wt. % or at least about 5.0 wt. % or at least about 8.0 wt. % or even at least about 10 wt. %. According to yet other embodiments, the composite material 100 may include an insulative filler component content of not greater than about 20.0 wt. % for a total weight of the composite material, such as, not greater than about 18.0 wt. % or even not greater than about 15.0 wt. %. It will be appreciated that the insulative filler component content of the composite material 100 may be within a range between any of the values noted above. It will be further appreciated that the insulative filler component content of the composite material 100 may be any value between any of the values noted above.

According to yet other embodiments, the insulative filler component 130 may have a particular density. For example, the insulative filler component 130 may have a density of not greater than about 0.6 g/cm³, such as, at least about 0.55 g/cm³ or not greater than about 0.5 g/cm³ or not greater than about 0.45 g/cm³ or not greater than about 0.4 g/cm³ or not greater than about 0.35 g/cm³ or not greater than about 0.3 g/cm³ or not greater than about 0.25 g/cm³ or not greater than about 0.20 g/cm³ or not greater than about 0.15 g/cm³ or not greater than about 0.1 g/cm³. According to still other embodiments, the insulative filler component 130 may have a density of at least about 0.001 g/cm³. It will be appreciated that the density of the insulative filler component may be within a range between any of the values noted above. It will be further appreciated that the density of the insulative filler component may be any value between any of the values noted above.

According to yet other embodiments, the insulative filler component 130 may have a particular melting point as measured by 1) heating a sample of the filler component to 600° C., or 700° C., or 800° C., and 1000° C. in a muffle furnace by maintaining the heating rate at 10° C./min and holding sample at the designed temperature for 0.2 hour, and 2) observing whether the sample was molten at the designed temperature. For example, the insulative filler component 130 may have a melting point of at least about 600° C., such as, at least about 650° C. or at least about 700° C. or even at least about 750° C. It will be appreciated that the melting point of the insulative filler component may be within a range between any of the values noted above. It will be further appreciated that the melting point of the insulative filler component may be any value between any of the values noted above.

According to particular embodiments, the enhancing filler composition may include an opacifying filler component.

According to still other embodiments, the opacifying filler component may include a component selected from the group consisting of silicon carbide, titanium dioxide, carbon black, graphite, zirconium dioxide, zirconium silicate, heavy metal oxides, zinc oxide, tin oxide, manganese oxide, nickel oxide, titanium carbide, tungsten carbide, iron oxide, ilmenite, silicon, silicon dioxide, aluminum, aluminum oxide, alumina, clay, metallic and nonmetallic particles, fibers, pigments, or any combination thereof. According to a particular embodiment, the opacifying filler component may consist essentially of a component selected from the group consisting of silicon carbide, titanium dioxide, carbon black, graphite, zirconium dioxide, zirconium silicate, heavy metal oxides, zinc oxide, tin oxide, manganese oxide, nickel oxide, titanium carbide, tungsten carbide, iron oxide, ilmenite, silicon, silicon dioxide, aluminum, aluminum oxide, alumina, clay, metallic and nonmetallic particles, fibers, pigments, or any combination thereof.

According to still other embodiments, the opacifying filler component may have a particular average particle size as measured by 1) preparing a sample of the filler by dispersing the component in isopropanol and running it in an ultrasonic bath for 1 minute at 40 W to break any agglomerates, 2) adding the sample drop-wise into the reservoir of a Horiba LA950 Laser Particle Analyzer, and 3) using the Horiba LA950 Laser Particle Analyzer to measure the particle size distribution of the sample. For example, the opacifying filler component may have an average particle size of at least about 0.10 μm, such as, at least about 0.20 μm or at least about 0.30 μm or at least about 0.40 μm or at least about 0.50 μm or at least about 0.60 μm or at least about 0.70 μm or at least about 0.80 μm or at least about 0.90 μm or at least about 1.0 μm or at least about 1.5 μm or at least about 2.0 μm or at least about 2.5 μm or at least about 3.0 μm or at least about 3.5 μm or at least about 4.0 μm or even at least about 4.5 μm. According to still other embodiments, the opacifying filler component may have an average particle size of not greater than about 10 μm, such as, not greater than about 9.5 μm or not greater than about 9.0 μm or not greater than about 8.5 μm or not greater than about 8.0 μm or not greater than about 7.5 μm or not greater than about 7.0 μm or not greater than about 6.5 μm or not greater than about 6.0 μm or even not greater than about 5.5 μm. It will be appreciated that the average particle size of the opacifying filler component may be within a range between any of the values noted above. It will be further appreciated that the average particle size of the opacifying filler component may be any value between any of the values noted above.

According to still other embodiments, the opacifying filler component may comprise titanium dioxide and the titanium dioxide may have a particular average particle size as measured by 1) preparing a sample of the filler by dispersing the component in isopropanol and running it in an ultrasonic bath for 1 minute at 40 W to break any agglomerates, 2) adding the sample drop-wise into the reservoir of a Horiba LA950 Laser Particle Analyzer, and 3) using the Horiba LA950 Laser Particle Analyzer to measure the particle size distribution of the sample. For example, the titanium dioxide may have an average particle size of at least about 0.10 μm, such as, at least about 0.20 μm or at least about 0.30 μm or at least about 0.40 μm or at least about 0.50 μm or at least about 0.60 μm or at least about 0.70 μm or at least about 0.80 μm or at least about 0.90 μm or at least about 1.0 μm or at least about 1.5 μm or at least about 2.0 μm or at least about 2.5 μm or at least about 3.0 μm or at least about 3.5 μm or at least about 4.0 μm or even at least about 4.5 μm. According to still other embodiments, the titanium dioxide may have an average particle size of not greater than about 10 μm, such as, not greater than about 9.5 μm or not greater than about 9.0 μm or not greater than about 8.5 μm or not greater than about 8.0 μm or not greater than about 7.5 μm or not greater than about 7.0 μm or not greater than about 6.5 μm or not greater than about 6.0 μm or even not greater than about 5.5 μm. It will be appreciated that the average particle size of the titanium dioxide may be within a range between any of the values noted above. It will be further appreciated that the average particle size of the titanium dioxide may be any value between any of the values noted above.

According to still other embodiments, the opacifying filler component may comprise aluminum oxide and the aluminum oxide may have a particular average particle size as measured by 1) preparing a sample of the filler by dispersing the component in isopropanol and running it in an ultrasonic bath for 1 minute at 40 W to break any agglomerates, 2) adding the sample drop-wise into the reservoir of a Horiba LA950 Laser Particle Analyzer, and 3) using the Horiba LA950 Laser Particle Analyzer to measure the particle size distribution of the sample. For example, the aluminum oxide may have an average particle size of at least about 0.50 μm, such as, at least about 0.55 μm or at least about 0.60 μm or at least about 0.65 μm or at least about 0.70 μm or at least about 0.75 μm or at least about 0.80 μm or at least about 0.85 μm or at least about 0.90 μm or at least about 1.0 μm or at least about 1.5 μm or at least about 2.0 μm or at least about 2.5 μm or at least about 3.0 μm or at least about 3.5 μm or at least about 4.0 μm or even at least about 4.5 μm. According to still other embodiments, the aluminum oxide may have an average particle size of not greater than about 10 μm, such as, not greater than about 9.5 μm or not greater than about 9.0 μm or not greater than about 8.5 μm or not greater than about 8.0 μm or not greater than about 7.5 μm or not greater than about 7.0 μm or not greater than about 6.5 μm or not greater than about 6.0 μm or even not greater than about 5.5 μm. It will be appreciated that the average particle size of the aluminum oxide may be within a range between any of the values noted above. It will be further appreciated that the average particle size of the aluminum oxide may be any value between any of the values noted above.

According to still other embodiments, the opacifying filler component may comprise silicon carbide and the silicon carbide may have a particular average particle size as measured by 1) preparing a sample of the filler by dispersing the component in isopropanol and running it in an ultrasonic bath for 1 minute at 40 W to break any agglomerates, 2) adding the sample drop-wise into the reservoir of a Horiba LA950 Laser Particle Analyzer, and 3) using the Horiba LA950 Laser Particle Analyzer to measure the particle size distribution of the sample. For example, the silicon carbide may have an average particle size of at least about 0.20 μm, such as, at least about 0.25 μm or at least about 0.30 μm or at least about 0.35 μm or at least about 0.40 μm or at least about 0.45 μm or at least about 0.50 μm or at least about 1.0 μm or at least about 1.5 μm or at least about 2.0 μm or at least about 2.5 μm or at least about 3.0 μm or at least about 3.5 μm or at least about 4.0 μm or even at least about 4.5 μm. According to still other embodiments, the silicon carbide may have an average particle size of not greater than about 10 μm, such as, not greater than about 9.5 μm or not greater than about 9.0 μm or not greater than about 8.5 μm or not greater than about 8.0 μm or not greater than about 7.5 μm or not greater than about 7.0 μm or not greater than about 6.5 μm or not greater than about 6.0 μm or even not greater than about 5.5 μm. It will be appreciated that the average particle size of the silicon carbide may be within a range between any of the values noted above. It will be further appreciated that the average particle size of the silicon carbide may be any value between any of the values noted above.

According to still other embodiments, the opacifying filler component may comprise graphite and the graphite may have a particular average particle size as by 1) preparing a sample of the filler by dispersing the component in isopropanol and running it in an ultrasonic bath for 1 minute at 40 W to break any agglomerates, 2) adding the sample drop-wise into the reservoir of a Horiba LA950 Laser Particle Analyzer, and 3) using the Horiba LA950 Laser Particle Analyzer to measure the particle size distribution of the sample. For example, the graphite may have an average particle size of at least about 0.10 μm, such as, at least about 0.20 μm or at least about 0.30 μm or at least about 0.40 μm or at least about 0.50 μm or at least about 0.60 μm or at least about 0.70 μm or at least about 0.80 μm or at least about 0.90 μm or at least about 1.0 μm or at least about 1.5 μm or at least about 2.0 μm or at least about 2.5 μm or at least about 3.0 μm or at least about 3.5 μm or at least about 4.0 μm or even at least about 4.5 μm. According to still other embodiments, the graphite may have an average particle size of not greater than about 10 μm, such as, not greater than about 9.5 μm or not greater than about 9.0 μm or not greater than about 8.5 μm or not greater than about 8.0 μm or not greater than about 7.5 μm or not greater than about 7.0 μm or not greater than about 6.5 μm or not greater than about 6.0 μm or even not greater than about 5.5 μm. It will be appreciated that the average particle size of the graphite may be within a range between any of the values noted above. It will be further appreciated that the average particle size of the graphite may be any value between any of the values noted above.

According to certain embodiments, the composite material 100 may include a particular content of the opacifying filler component. For example, the composite material 100 may include an opacifying filler component content of at least about 3.0 wt. % for a total weight of the composite material, such as, at least about 4.0 wt. % or at least about 5.0 wt. % or at least about 8.0 wt. % or even at least about 10 wt. %. According to yet other embodiments, the composite material 100 may include an opacifying filler component content of not greater than about 30.0 wt. % for a total weight of the composite material, such as, not greater than about 25.0 wt. % or even not greater than about 20.0 wt. %. It will be appreciated that the opacifying filler component content of the composite material 100 may be within a range between any of the values noted above. It will be further appreciated that the opacifying filler component content of the composite material 100 may be any value between any of the values noted above.

According to particular embodiments, the enhancing filler composition may include a stabilizing filler component.

According to still other embodiments, the stabilizing filler component may include a component selected from the group consisting of iron oxide, wallastonite, mica, kaolin, clay, talc, vermiculite, cerium oxide, titanium dioxide, or any combination thereof. According to a particular embodiment, the stabilizing filler component may consist essentially of a component selected from the group consisting iron oxide, wallastonite, mica, kaolin, clay, talc, vermiculite, cerium oxide, titanium dioxide, or any combination thereof.

According to certain embodiments, the composite material 100 may include a particular content of the stabilizing filler component. For example, the composite material 100 may include a stabilizing filler component content of at least about 3.0 wt. % for a total weight of the composite material, such as, at least about 4.0 wt. % or at least about 5.0 wt. % or at least about 8.0 wt. % or even at least about 10 wt. %. According to yet other embodiments, the composite material 100 may include a stabilizing filler component content of not greater than about 15.0 wt. % for a total weight of the composite material, such as, not greater than about 14.0 wt. % or even not greater than about 13.0 wt. %. It will be appreciated that the stabilizing filler component content of the composite material 100 may be within a range between any of the values noted above. It will be further appreciated that the stabilizing filler component content of the composite material 100 may be any value between any of the values noted above.

According to still other embodiments, the composite material 100 may have a particular hot plate cold side heating rate percentage increase (CSHRI_{HP}), where the CSHRI_{HP} is equal to the percentage increase of the hot plate cold side heating rate of the composite material as compared to the hot plate cold side heating rate of a TRP 1000 reference composite material. For purposes of embodiments described herein, the hot plate test is carried out by preparing a 1-inch by 1-inch specimen of the material, which is put on top of a hot plate. A thermal couple is fixed in a lid that is put on top of the specimen to measure the cold side surface temperature. The temperature curve is recorded and the point, if any, of self-ignition is recorded. According to certain embodiments, the composite material 100 may have a CSHRI_{HP} of at least about 2.0%, such as, at least about 2.5% or at least about 3.0% or at least about 3.5% or at least about 4.0% or at least about 4.5% or even at least about 5.0%. It will be appreciated that the composite material 100 may have a CSHRI_{HP} within a range between any of the values noted above. It will be further appreciated that the composite material 100 may have a CSHRI_{HP} between any of the values noted above.

According to still other embodiments, the composite material 100 may have a particular length shrinkage percentage improvement, where the length shrinkage percentage improvement is equal to the percentage improvement of the length shrinkage of the composite material as compared to the length shrinkage of a TRP 1000 reference composite material. For purposes of embodiments described herein, the length shrinkage of a material is equal to the percentage change in length after placement in a furnace at a temperature of 800° C. for 12 minutes. According to certain embodiments, the composite material 100 may have a length shrinkage percentage improvement of at least about 40.0%, such as, at least about 41.0% or at least about 42.0% or at least about 43.0% or at least about 44.0% or even at least about 45.0%. It will be appreciated that the composite material 100 may have a length shrinkage percentage improvement within a range between any of the values noted above. It will be further appreciated that the composite material 100 may have a length shrinkage percentage improvement between any of the values noted above.

According to still other embodiments, the composite material 100 may have a particular thickness shrinkage percentage improvement, where the thickness shrinkage percentage improvement is equal to the percentage improvement of the thickness shrinkage of the composite material as compared to the thickness shrinkage of a TRP 1000 reference composite material. For purposes of embodiments described herein, the thickness shrinkage of a material is equal to the percentage change in thickness after placement in a furnace at a temperature of 800° C. for 12 minutes. According to certain embodiments, the composite material 100 may have a thickness shrinkage percentage improvement of at least about 20.0%, such as, at least about 21.0% or at least about 22.0% or at least about 23.0% or at least about 24.0% or even at least about 25.0%. It will be appreciated that the composite material 100 may have a thickness shrinkage percentage improvement within a range between any of the values noted above. It will be further appreciated that the composite material 100 may have a thickness shrinkage percentage improvement between any of the values noted above.

According to still other embodiments, the composite material 100 may have a particular volume shrinkage percentage improvement, where the volume shrinkage percentage improvement is equal to the percentage improvement of the volume shrinkage of the composite material as compared to the volume shrinkage of a TRP 1000 reference composite material. For purposes of embodiments described herein, the volume shrinkage of a material is equal to the percentage change in volume after placement in a furnace at a temperature of 800° C. for 12 minutes. According to certain embodiments, the composite material 100 may have a volume shrinkage percentage improvement of at least about 40.0%, such as, at least about 41.0% or at least about 42.0% or at least about 43.0% or at least about 44.0% or even at least about 45.0%. It will be appreciated that the composite material 100 may have a volume shrinkage percentage improvement within a range between any of the values noted above. It will be further appreciated that the composite material 100 may have a volume shrinkage percentage improvement between any of the values noted above.

According to yet other embodiments, the composite material 100 may have a particular flammability rating. For example, the composite material 100 may have a HBF flammability rating as measured according to ASTM D4986.

According to certain embodiments, the composite material 100 may have a particular flammability rating as measured according to ASTM D3801. In particular, the composite material 100 may have a V-O flammability rating as measured according to ASTM D3801.

According to still other embodiments, the composite material 100 may have a particular thermal conductivity percentage improvement, where the thermal conductivity percentage improvement is equal to the percentage improvement of the thermal conductivity of the composite material as compared to the thermal conductivity of a TRP 1000 reference composite material. It will be appreciated that for purposes of embodiments described herein, improvement is considered to be a lowering of the thermal conductivity of a sample. For purposes of embodiments described herein, the thermal conductivity is measured using a transient plane source device (MP-1 ThermTest), where 1) a sensor is placed between two pieces of a sample which are insulated with foam, 2) a pulse of heat is then introduced via the sensor, and 3) the temperature change within the sample is measured and used the calculate the thermal conductivity. For purposes of embodiments described herein, the sensor model used for the measurement is 3317, the power supplied for the heat pulse ranged from 20-90 mW with test times of 5-40 seconds, measurements were calculated using the Therm Test software, and the slab method was used to measure conductivity of samples. According to certain embodiments, the composite material 100 may have a thermal conductivity percentage improvement of at least about 2.0%, such as, at least about 3.0% or at least about 4.0% or at least about 5.0% or at least about 6.0% or even at least about 7.0%. It will be appreciated that the composite material 100 may have a thermal conductivity percentage improvement within a range between any of the values noted above. It will be further appreciated that the composite material 100 may have a thermal conductivity percentage improvement between any of the values noted above.

According to still other embodiments, the composite material 100 may have a particular high temperature thermal conductivity percentage improvement, where the high temperature thermal conductivity percentage improvement is equal to the percentage improvement of the high temperature thermal conductivity of the composite material as compared to the high temperature thermal conductivity of a TRP 1000 reference composite material. It will be appreciated that for purposes of embodiments described herein, improvement is considered to be a lowering of the high temperature thermal conductivity of a sample. Further, for purposes of embodiments described herein, the high temperature thermal conductivity is measured according to ASTM C518 at a temperature of 800° C. According to certain embodiments, the composite material 100 may have a high temperature thermal conductivity percentage improvement of at least about 5.0%, such as, at least about 6.0% or at least about 7.0% or at least about 8.0% or at least about 9.0% or at least about 10% or at least about 11% or at least about 12% or at least about 13% or at least about 14% or at least about 15% or at least about 16.0% or at least about 17.0% or at least about 18.0% or at least about 19.0% or even at least about 20.0%. It will be appreciated that the composite material 100 may have a high temperature thermal conductivity percentage improvement within a range between any of the values noted above. It will be further appreciated that the composite material 100 may have a high temperature thermal conductivity percentage improvement between any of the values noted above.

According to yet other embodiments, the composite material 100 may be a layer having a particular thickness. For example, the composite material 100 may be a layer having a thickness of at least about 0.5 mm, such as, at least about 1.0 mm or at least about 1.5 mm or at least about 2.0 mm or at least about 2.5 mm or at least about 3.0 mm or at least about 3.5 mm or at least about 4.0 mm or at least about 4.5 mm or even at least about 5.0 mm. According to still other embodiments, the composite material 100 may be a layer having a thickness of not greater than about 20 mm, such as, not greater than about 19 mm or not greater than about 18 mm or not greater than about 17 mm or not greater than about 16 mm or not greater than about 15 mm or not greater than about 14 mm or not greater than about 13 mm or not greater than about 12 mm or not greater than about 11 mm or not greater than about 10 mm or not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or even not greater than about 6.0 mm. It will be appreciated that the thickness of a layer of the composite material 100 may be within a range between any of the minimum and maximum values noted above. It will be further appreciated that the thickness of a layer of the composite material 100 may be any value between any of the minimum and maximum values noted above.

According to yet other embodiments, the composite material 100 may have a particular density. For purposes of embodiments described herein, the density of the composite material 100 may be determined according to ASTM D1056. According to certain embodiments, the composite material 100 may have a density of not greater than about 1500 kg/m³, such as, not great than about 1475 kg/m³ or not greater than about 1450 kg/m³ or not greater than about 1425 kg/m³ or not greater than about 1400 kg/m³ or not greater than about 1350 kg/m³ or not greater than about 1300 kg/m³ or not greater than about 1250 kg/m³ or not greater than about 1200 kg/m³ or not greater than about 1150 kg/m³ or not greater than about 1100 kg/m³ or not greater than about 1050 kg/m³ or not greater than about 1000 kg/m³ or even not greater than about 950 kg/m³. According to yet other embodiments, the composite material 100 may have a density of at least about 100 kg/m³, such as, at least about 120 kg/m³ or at least about 140 kg/m³ or at least about 160 kg/m³ or at least about 180 kg/m³ or at least about 200 kg/m³ or at least about 220 kg/m³ or even at least about 240 kg/m³. It will be appreciated that the density of the composite material 100 may be within a range between any of the minimum and maximum values noted above. It will be further appreciated that the density of the composite material 100 may be any value between any of the minimum and maximum values noted above.

According to yet other embodiments, the composite material 100 may have a particular 25% strain compression rating. For purposes of embodiments described herein, the 25% strain compression rating is defined as the compression rating of a sample measure at a 25% strain and is determined by measuring the force-to-compress and compression-force-deflection of the sample at a 25% strain. Force-to-compress (FTC) is defined as the peak force (or stress) to compress the sample to a predetermined strain and compression-force-deflection (CFD) is defined as the plateau or relaxation force (or stress) retained by a sample when held at the desired strain (i.e., 25%). Measurements are made using a Texture Analyzer, which finds and records both FTC values and CFD values after a hold time of 60 seconds, a compression speed of 0.16 mm/s and a trigger force of 10 grams. According to certain embodiments, the composite material 100 may have a 25% strain compression rating of not greater than about 1500 kPa, such as, not greater than about 1400 kPa or not greater than about 1300 kPa or not greater than about 1200 kPa or not greater than about 1100 kPa or not greater than about 1000 kPa or not greater than about 900 kPa or not greater than about 800 kPa or not greater than about 700 kPa or not greater than about 600 kPa or not greater than about 500 kPa or not greater than about 400 kPa or not greater than about 300 kPa or not greater than about 200 kPa or not greater than about 150 kPa or not greater than about 125 kPa or not greater than about 100 kPa. According to still other embodiments, the composite material 100 may have a 25% strain compression rating of at least about 5 kPa, such as, at least about 10 kPa or at least about 15 kPa or at least about 20 kPa or at least about 25 kPa. It will be appreciated that the 25% strain compression rating of the composite material 100 may be within a range between any of the minimum and maximum values noted above. It will be further appreciated that the 50% strain compression rating of the multilayer composite 100 may be any value between any of the minimum and maximum values noted above.

According to yet other embodiments, the composite material 100 may have a particular thermal conductivity as measured according to ASTM C518. For example, the composite material 100 may have a thermal conductivity of at least about 0.01 W/mK, such as, at least about 0.02 W/mK or at least about 0.03 W/mK or at least about 0.04 W/mK or even at least about 0.05 W/mK. According to still other embodiments, the composite material 100 may have a thermal conductivity of not greater than about 0.15 W/mK, such as, not greater than about 0.14 W/mK or not greater than about 0.13 W/mK or not greater than about 0.12 W/mK or not greater than about 0.11 W/mK or not greater than about 0.10 W/mK or not greater than about 0.09 W/mK or not greater than about 0.08 W/mK or even not greater than about 0.07 W/mK. It will be appreciated that the thermal conductivity of the composite material 100 may be within a range between any of the minimum and maximum values noted above. It will be further appreciated that the thermal conductivity of the composite material 100 may be any value between any of the minimum and maximum values noted above.

According to certain embodiments, the composite material 100 described herein may be formed according to any acceptable forming process for a composite material 100. According to certain embodiments, the composite material 100 described herein may be formed as a composite material layer according to any acceptable forming process for a layer of composite material 100.

Turning now to additional embodiments described herein, such embodiments are generally directed to a multilayer component that include a layer of the composite material 100 as described herein overlying a backing layer. For purposes of embodiments described herein, it will be appreciated that the composite material layer may include a composite material having any of the characteristics of the composite material 100 described herein.

According to still other embodiments, the backing layer may include a mica based material. According to still other embodiments, the backing lay may include a non-mica based material. According to yet other embodiments, the non-mica based material may be selected from the group consisting of a glass fabric, a silica fabric, a basalt fabric, a vermiculite coated glass fabric, an aerogel, a non-woven glass fabric, ceramic fibers, any combination thereof.

Turning now to additional embodiments described herein, such embodiments are generally directed to a thermal barrier composite that may include a composite material layer formed according to embodiments described herein. For purposes of embodiments described herein, it will be appreciated that the composite material layer may include a composite material having any of the characteristics of the composite material 100 described herein.

According to certain embodiments, the thermal barrier composite described herein may be formed according to any acceptable forming process for a thermal barrier composite. According to a particular embodiment, the thermal barrier composite may be formed using a lamination process where the layer of the composite material and a barrier layer are laminated using a transfer adhesive such as, for example, a silicon adhesive, a rubber adhesive, an acrylic adhesive, a phenolic adhesive, a polyurethane based adhesive or any combination thereof. According to still other embodiments, the thermal barrier composite may be formed using a lamination process with a porous foam and a coated barrier layer, where the coating on the barrier layer is an adhesive, such as, a silicon adhesive, a rubber adhesive, an acrylic adhesive, a phenolic adhesive, a polyurethane based adhesive or any combination thereof. According to still other embodiments, the thermal barrier composite may be formed using a direct cast forming process, wherein the foam is directly cast onto the barrier films or between the barrier films.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A composite material comprising: a silicone-based matrix component, an endothermic filler component distributed within the silicone-based matrix component, an insulative filler component distributed within the silicone-based matrix component, and an enhancing filler composition distributed within the silicone-based matrix component, wherein the enhancing filler composition comprises an opacifying filler component, a stabilizing filler component, or any combination thereof.

Embodiment 2. A composite material layer of a composite material, wherein the composite material comprises: a silicone-based matrix component, an endothermic filler component distributed within the silicone-based matrix component, an insulative filler component distributed within the silicone-based matrix component, and an enhancing filler composition distributed within the silicone-based matrix component, wherein the enhancing filler composition comprises an opacifying filler component, a stabilizing filler component, or any combination thereof.

Embodiment 3. The composite material or composite material layer of any one of embodiments 1 and 2, wherein the silicone-based matrix component comprises a foam material.

Embodiment 4. The composite material or composite material layer of any one of embodiments 1 and 2, wherein the silicone-based matrix component comprises a solid material.

Embodiment 5. The composite material or composite material layer of embodiment 3, wherein the silicone-based matrix component comprises a porosity of at least about 10%.

Embodiment 6. The composite material or composite material layer of embodiment 3, wherein the silicone-based matrix component comprises a porosity of not greater than about 80%.

Embodiment 7. The composite material or composite material layer of embodiment 4, wherein the silicone-based matrix component comprises a hardness of at least about Shore00 25 as measured using a durometer.

Embodiment 8. The composite material or composite material layer of embodiment 4, wherein the silicone-based matrix component comprises a hardness of not greater than about ShoreD 40 as measured using a durometer.

Embodiment 9. The composite material or composite material layer of any one of embodiments 1 and 2, wherein the composite material comprises a silicone-based matrix component content of at least about 10 wt. % for a total weight of the composite material.

Embodiment 10. The composite material or composite material layer of any one of embodiments 1 and 2, wherein the composite material comprises a silicone-based matrix component content of not greater than about 66 wt. % for a total weight of the composite material.

Embodiment 11. The composite material or composite material layer of any one of embodiments 1 and 2, wherein the endothermic filler component comprises a component selected from the group consisting of a metal hydrate, a metal hydroxide, a metal silicate, a metal carbonate, a metal bicarbonate, an aluminum oxide, an ammonium nitrate, a metal sulphate, a metal phosphate, and any combination thereof.

Embodiment 12. The composite material or composite material layer of embodiment 11, wherein the endothermic filler component comprises a metal hydrate, and wherein the metal hydrate comprises aluminum trihydrate, zinc borate, hydromagnesite, gypsum, sodium tetraborate decahydrate, or magnesium phosphate octahydrate.

Embodiment 13. The composite material or composite material layer of embodiment 11, wherein the endothermic filler component comprises a metal hydroxide, and wherein the metal hydroxide comprises magnesium hydroxide, dihydroxide, trihydroxide, dawsonite, or calcium hydroxide.

Embodiment 14. The composite material or composite material layer of embodiment 11, wherein the endothermic filler component comprises a metal silicate, and wherein the metal silicate comprises hydrous sodium silicate.

Embodiment 15. The composite material or composite material layer of embodiment 11, wherein the endothermic filler component comprises a metal carbonate, and wherein the metal carbonate comprises nesquehonite, magnesium carbonate, Huntite, dawsonite, or anhydrous carbonates.

Embodiment 16. The composite material or composite material layer of embodiment 11, wherein the endothermic filler component comprises a metal bicarbonate, and wherein the metal bicarbonate comprises sodium bicarbonate.

Embodiment 17. The composite material or composite material layer of embodiment 11, wherein the endothermic filler component comprises an aluminum oxide, wherein the aluminum oxide comprises boehmite.

Embodiment 18. The composite material or composite material layer of embodiment 11, wherein the endothermic filler component comprises a metal hydrate, and wherein the metal hydrate comprises ammonium nitrate.

Embodiment 19. The composite material or composite material layer of embodiment 11, wherein the endothermic filler component comprises a metal sulphate, wherein the metal sulphate comprises anhydrous sulphate.

Embodiment 20. The composite material or composite material layer of embodiment 11, wherein the endothermic filler component comprises a metal phosphate, wherein the metal phosphate comprises anhydrous phosphate.

Embodiment 21. The composite material or composite material layer of any one of embodiments 1 and 2, wherein the composite material comprises an endothermic filler component content of at least about 15.00 wt. % for a total weight of the composite material.

Embodiment 22. The composite material or composite material layer of any one of embodiments 1 and 2, wherein the composite material comprises an endothermic filler component content of not greater than about 75.0 wt. % for a total weight of the composite material.

Embodiment 23. The composite material or composite material layer of any one of embodiments 1 and 2, wherein the insulative filler component comprises a component selected from the group consisting of perlite, hollow glass beads, aerogel, expanded perlite, unexpanded perlite, glass beads, ceramic beads, vermiculite, expanded vermiculite, expanded glass, zeolite, aerogel, silica, porous silica, porous alumina, or any combination thereof.

Embodiment 24. The composite material or composite material layer of any one of embodiments 1 and 2, wherein the composite material comprises an insulative filler content of at least about 1.0 wt. % for a total weight of the composite material.

Embodiment 25. The composite material or composite material layer of any one of embodiments 1 and 2, wherein the composite material comprises an insulative filler content of not greater than about 20.0 wt. % for a total weight of the composite material.

Embodiment 26. The composite material or composite material layer of any one of embodiments 1 and 2, wherein the insulative filler component comprises a density of not greater than about 0.6 g/cm³.

Embodiment 27. The composite material or composite material layer of any one of embodiments 1 and 2, wherein the insulative filler component comprises a density of at least about 0.001 g/cm³.

Embodiment 28. The composite material or composite material layer of any one of embodiments 1 and 2, wherein the insulative fuller component comprises a melting point of at least about 600° C.

Embodiment 29. The composite material or composite material layer of any one of embodiments 1 and 2, wherein the composite material comprises an opacifying filler component.

Embodiment 30. The composite material or composite material layer of embodiment 29, wherein the opacifying filler component comprise an average particle size of at least about 0.10 μm.

Embodiment 31. The composite material or composite material layer of embodiment 29, wherein the opacifying filler component comprise an average particle size of not greater than about 10.0 μm.

Embodiment 32. The composite material or composite material layer of embodiment 29, wherein the opacifying filler component comprises a component selected from the group consisting of silicon carbide, titanium dioxide, carbon black, graphite, zirconium dioxide, zirconium silicate, heavy metal oxides, zinc oxide, tin oxide, manganese oxide, nickel oxide, titanium carbide, tungsten carbide, iron oxide, ilmenite, silicon, silicon dioxide, aluminum, aluminum oxide, alumina, clay, metallic and nonmetallic particles, fibers, pigments, or any combination thereof.

Embodiment 33. The composite material or composite material layer of embodiment 29, wherein the opacifying filler component comprises titanium dioxide.

Embodiment 34. The composite material or composite material layer of embodiment 33, wherein the opacifying filler component comprises an average particle size of at least about 0.10 μm.

Embodiment 35. The composite material or composite material layer of embodiment 33, wherein the opacifying filler component comprises an average particle size of not greater than about 10.0 μm.

Embodiment 36. The composite material or composite material layer of embodiment 29, wherein the opacifying filler component comprises aluminum oxide.

Embodiment 37. The composite material or composite material layer of embodiment 36, wherein the opacifying filler component comprises an average particle size of at least about 0.50 μm.

Embodiment 38. The composite material or composite material layer of embodiment 36, wherein the opacifying filler component comprises an average particle size of not greater than about 10.0 μm.

Embodiment 39. The composite material or composite material layer of embodiment 29, wherein the opacifying filler component comprises silicon carbide.

Embodiment 40. The composite material or composite material layer of embodiment 39, wherein the opacifying filler component comprises an average particle size of at least about 0.20 μm.

Embodiment 41. The composite material or composite material layer of embodiment 39, wherein the opacifying filler component comprises an average particle size of not greater than about 10.0 μm.

Embodiment 42. The composite material or composite material layer of embodiment 29, wherein the opacifying filler component comprises graphite.

Embodiment 43. The composite material or composite material layer of embodiment 41, wherein the opacifying filler component comprises an average particle size of at least about 0.10 μm.

Embodiment 44. The composite material or composite material layer of embodiment 41, wherein the opacifying filler component comprises an average particle size of not greater than about 10.0 μm.

Embodiment 45. The composite material or composite material layer of embodiment 29, wherein the composite material comprises an opacifying filler content of at least about 3.0 wt. % for a total weight of the composite material.

Embodiment 46. The composite material or composite material layer of embodiment 29, wherein the composite material comprises an opacifying filler content of not greater than about 30.0 wt. % for a total weight of the composite material.

Embodiment 47. The composite material or composite material layer of any one of embodiments 1 and 2, wherein the composite material comprises a stabilizing filler component.

Embodiment 48. The composite material or composite material layer of embodiment 47, wherein the stabilizing filler component comprises a component selected from the group consisting iron oxide, wallastonite, mica, kaolin, clay, talc, vermiculite, cerium oxide, titanium dioxide, or any combination thereof.

Embodiment 49. The composite material or composite material layer of embodiment 47, wherein the composite material comprises a stabilizing filler content of at least about 3.0 wt. % for a total weight of the composite material.

Embodiment 50. The composite material or composite material layer of embodiment 47, wherein the composite material comprises a stabilizing filler content of not greater than about 15.0 wt. % for a total weight of the composite material.

Embodiment 51. The composite material or composite material layer of any one of embodiments 1 and 2, wherein the composite material comprises a hot plate cold side heating rate percentage increase (CSHRI_{HP}) of at least about 2.0%, where the CSHRI_{HP} is equal to the percentage increase of the hot plate cold side heating rate of the composite material as compared to the hot plate cold side heating rate of a TRP 1000 reference composite material.

Embodiment 52. The composite material or composite material layer of any one of embodiments 1 and 2, wherein the composite material comprises a length shrinkage percentage improvement of at least about 40%, where the length shrinkage percentage improvement is equal to the percentage change of the length shrinkage of the composite material as compared to the length shrinkage of a TRP 1000 reference composite material.

Embodiment 53. The composite material or composite material layer of any one of embodiments 1 and 2, wherein the composite material comprises a thickness shrinkage percentage improvement of at least about 20%, where the thickness shrinkage percentage improvement is equal to the percentage change of the thickness shrinkage of the composite material as compared to the length shrinkage of a TRP 1000 reference composite material.

Embodiment 54. The composite material or composite material layer of any one of embodiments 1 and 2, wherein the composite material comprises a volume shrinkage percentage improvement of at least about 40%, where the volume shrinkage percentage improvement is equal to the percentage change of the volume shrinkage of the composite material as compared to the length shrinkage of a TRP 1000 reference composite material.

Embodiment 55. The composite material or composite material layer of any one of embodiments 1 and 2, wherein the composite material comprises a flammability rating of at least HBF as measured according to ASTM D4986.

Embodiment 56. The composite material or composite material layer of any one of embodiments 1 and 2, wherein the composite material comprises a thermal conductivity percentage improvement of at least about 2.0%, where the thermal conductivity percentage improvement is equal to the percentage change of the thermal conductivity of the composite material as compared to the thermal conductivity of a TRP 1000 reference composite material.

Embodiment 57. The composite material or composite material layer of any one of embodiments 1 and 2, wherein the composite material layer comprises a thickness of at least about 0.5 mm.

Embodiment 58. The composite material or composite material layer of any one of embodiments 1 and 2, wherein the composite material layer comprises a thickness of not greater than about 20 mm.

Embodiment 59. The composite material or composite material layer of any one of embodiments 1 and 2, wherein the composite material comprises a density of at least about 100 kg/m³.

Embodiment 60. The composite material or composite material layer of any one of embodiments 1 and 2, wherein the composite material layer comprises a thickness of not greater than about 1500 kg/m³.

Embodiment 61. The composite material or composite material layer of any one of embodiments 1 and 2, wherein the composite material comprises a 25% strain compression rating of at least about 5 kPa.

Embodiment 62. The composite material or composite material layer of any one of embodiments 1 and 2, wherein the composite material comprises a 25% strain compression rating of not greater than about 1500 kPa.

Embodiment 63. The composite material or composite material layer of any one of embodiments 1 and 2, wherein the composite material comprises a compression set rating of not greater than about 25%.

Embodiment 64. A multilayer component comprises a composite material layer overlying backing layer, wherein the composite material comprises: a silicone-based matrix component, an endothermic filler component distributed within the silicone-based matrix component, an insulative filler component distributed within the silicone-based matrix component, and an enhancing filler composition distributed within the silicone-based matrix component, wherein the enhancing filler composition comprises an opacifying filler component, a stabilizing filler component, or any combination thereof.

Embodiment 65. The multilayer composite of embodiment 64, wherein the backing layer comprises a mica material.

Embodiment 66. The multilayer composite of embodiment 64, wherein the backing layer comprises a non-mica material.

Embodiment 67. The multilayer composite of embodiment 66, wherein the non-mica material comprises a material selected from the group consisting of a glass fabric, a silica fabric, a basalt fabric, a vermiculite coated glass fabric, an aerogel, a non-woven glass fabric, ceramic fibers, any combination thereof.

### EXAMPLES

The concepts described herein will be further described in the following Examples, which do not limit the scope of the invention described in the claims.

### Example 1

Four sample composite materials S1, S2, S3, and S4 were formed according to embodiments described herein. Three comparative sample composite material CS1, CS2, and CS3 were formed for comparison to the sample composite materials S1, S2, S3, and S4. The construction and composition of each composite S1, S2, S3, S4, CS1, CS2, and CS3 are summarized in table 1 below.

TABLE 1
Composite Compositions

| | Silicone-Based | Endothermic | Insulative | Enhancing |
|---|---|---|---|---|
| | Matrix | Filler | Filler | Filler |
| | (wt. % per | (wt. % per total | (wt. % per | (wt. % per total |
| | total weight of | weight of | total weight of | weight of |
| Sample | composite) | composite) | composite) | composite) |
| S1 (K-Race 1) | 37.0 | 40.0 | 12.0 | 11.0 |
| S2 (K-Race 2) | 42.5 | 40.0 | 6.5 | 11.0 |
| S3 (26-19) | 49.5 | 30.0 | 10.0 | 10.5 |
| S4 (37-3) | 52.7 | 20.0 | 13.7 | 13.6 |
| CS1 (TRP1000) | 70.6-62.6 | 7-12 | 7.6 | 14.8 |
| CS2 (Race 3.2) | 40.0 | 60.0 | 0.0 | 0.0 |
| CS3 (K-Race 3) | 65.1 | 12.0 | 22.9 | 0.0 |

The performance (i.e., thermal conductivity improvement, thickness shrinkage improvement, and volume improvement) of each composite S1, S2, S3, S4, CS1, CS2, and CS3 are summarized in Table 2 below. It will be appreciated that all performance measurements were conducted as described herein.

TABLE 2
Composite Performance

| | Thermal | Thickness | Volume |
|---|---|---|---|
| | Conductivity | Shrinkage | Shrinkage |
| | Improvement | Improvement | Improvement |
| Sample | (%) | (%) | (%) |
| S1 (K-Race 1) | −43.0 | 32.6 | 46.6 |
| S2 (K-Race 2) | 4.0 | 36.6 | 41.4 |
| S3 (26-19) | 25 | 50.5 | 36.0 |
| S4 (37-3) | 22 | 1.0 | 17.2 |
| CS1 (TRP1000) | — | — | — |
| CS2 (Race 3.2) | −79 | −12.8 | 7.3 |
| CS3 (K-Race 3) | −7 | 20.1 | 30.5 |

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A composite material comprising:
a silicone-based matrix component,
an endothermic filler component distributed within the silicone-based matrix component,
an insulative filler component distributed within the silicone-based matrix component, and
an enhancing filler composition distributed within the silicone-based matrix component,
wherein the enhancing filler composition comprises an opacifying filler component, a stabilizing filler component, or any combination thereof.

2. The composite material of claim 1, wherein the silicone-based matrix component comprises a foam material.

3. The composite material of claim 1, wherein the silicone-based matrix component comprises a solid material.

4. The composite material of claim 1, wherein the silicone-based matrix component comprises a porosity of at least about 10%.

5. The composite material of claim 1, wherein the silicone-based matrix component comprises a porosity of not greater than about 80%.

6. The composite material of claim 1, wherein the silicone-based matrix component comprises a hardness of at least about Shore00 25 as measured using a durometer.

7. The composite material of claim 1, wherein the silicone-based matrix component comprises a hardness of not greater than about ShoreD 40 as measured using a durometer.

8. The composite material of claim 1, wherein the composite material comprises a silicone-based matrix component content of at least about 10 wt. % for a total weight of the composite material.

9. The composite material of claim 1, wherein the composite material comprises a silicone-based matrix component content of not greater than about 66 wt. % for a total weight of the composite material.

10. The composite material of claim 1, wherein the endothermic filler component comprises a component selected from the group consisting of a metal hydrate, a metal hydroxide, a metal silicate, a metal carbonate, a metal bicarbonate, an aluminum oxide, an ammonium nitrate, a metal sulphate, a metal phosphate, and any combination thereof.

11. The composite material of claim 10, wherein the endothermic filler component comprises a metal hydrate, and wherein the metal hydrate comprises aluminum trihydrate, zinc borate, hydromagnesite, gypsum, sodium tetraborate decahydrate, or magnesium phosphate octahydrate.

12. The composite material of claim 10, wherein the endothermic filler component comprises a metal hydroxide, and wherein the metal hydroxide comprises magnesium hydroxide, dihydroxide, trihydroxide, dawsonite, or calcium hydroxide.

13. A composite material layer of a composite material, wherein the composite material comprises:
a silicone-based matrix component,
an endothermic filler component distributed within the silicone-based matrix component,
an insulative filler component distributed within the silicone-based matrix component, and
an enhancing filler composition distributed within the silicone-based matrix component,
wherein the enhancing filler composition comprises an opacifying filler component, a stabilizing filler component, or any combination thereof.

14. The composite material layer of claim 13, wherein the silicone-based matrix component comprises a foam material.

15. The composite material layer of claim 13, wherein the silicone-based matrix component comprises a solid material.

16. The composite material layer of claim 13, wherein the silicone-based matrix component comprises a porosity of at least about 10%.

17. The composite material layer of claim 13, wherein the silicone-based matrix component comprises a porosity of not greater than about 80%.

18. The composite material layer of claim 13, wherein the silicone-based matrix component comprises a hardness of at least about Shore00 25 as measured using a durometer.

19. A multilayer component comprises a composite material layer overlying backing layer, wherein the composite material comprises:
a silicone-based matrix component,
an endothermic filler component distributed within the silicone-based matrix component,
an insulative filler component distributed within the silicone-based matrix component, and
an enhancing filler composition distributed within the silicone-based matrix component, wherein the enhancing filler composition comprises an opacifying filler component, a stabilizing filler component, or any combination thereof.

20. The multilayer composite of claim 19, wherein the backing layer comprises a mica material.
